(19) United States
(12) Patent Application Publication
(10) Pub. No.: US 2015/0280566 A1
(43) Pub. Date: Oct. 1, 2015

(54) SWITCH CIRCUIT FOR CONTROLLING SUPPLY OF ELECTRICAL ENERGY TO A LOAD

(71) Applicant: WISETOP TECHNOLOGY CO., LTD., Hsinchu City (TW)

(72) Inventors: PIN CHANG, Hsinchu City (TW); WEI-CHEN LIANG, Baoshan Township, Hsinchu County (TW)

(21) Appl. No.: 14/669,644

(22) Filed: Mar. 26, 2015

(30) Foreign Application Priority Data
Mar. 27, 2014 (TW) 103111572

(51) Int. Cl. H02M 3/158; H02M 3/156

(52) U.S. Cl. CPC H02M 3/158; H02M 3/156

(57) ABSTRACT

A switch circuit comprises an unidirectional power source module, an unidirectional load module, an inductor and a switch module. By controlling a switching operation of the switch module, the inductor is enabled to store or discharge the electrical energy so as to modulate the operating current. When the inductor supplies the electrical energy to the unidirectional load module, the inductor and the unidirectional load module consist of a loop. When the input voltage is at a higher potential, the switch circuit may control the operating current by the inductor's properties so as to modulate the operating power of the unidirectional load module, and when the input voltage is at a lower potential, the switch circuit still may store or discharge the electrical energy by switching the inductor so as to provide the operating current to the unidirectional load module.

### CROSS-REFERENCE TO RELATED APPLICATIONS

This application claims priority under 35 USC §119 to Taiwan Patent Application No. 103111572, filed on Mar. 27, 2014 in the Taiwan Intellectual Property Office (TIPO), the contents of which are herein incorporated by reference in their entirety.

### FIELD OF THE INVENTION

The present invention relates to a switch circuit, in particular to a switch circuit for controlling supply of electrical energy to a load.

### BACKGROUND OF THE INVENTION

With reference to FIG. 1 for a schematic diagram of a conventional switch circuit. The conventional switch circuit 100 is a boost converter, comprises an unidirectional power source module 10, a switch 11, an inductor 12, a light emitting diode (LED) 13 and a capacitor 15.

Wherein, the unidirectional power source module 10 having a first node and a second node may also be a bridge rectifier, which may rectify an alternating current (AC) power V_{AC} of a utility power to a pulsating direct current (DC) input voltage V_{IN}. One terminal of the inductor 12 is connected to the first node of the unidirectional power source module 10. A first terminal of the switch 11 is connected to the other terminal of the inductor 12, a control terminal of the switch 11 is configured to receive a control signal S, and a second terminal of the switch 11 is connected to the second node of the unidirectional power source module 10 by a load element. A first terminal of the LED 13 is connected to the first node of the unidirectional power source module 10 by a diode 121, and a second terminal of the LED 13 is connected to the second node of the unidirectional power source module 10 by a load element. The capacitor 15 is connected in parallel to the LED 13.

When the switch 11 is turned OFF, the conventional switch circuit 100 drives the LED 13 to emit light and charges the capacitor 15 simultaneously by the current discharged from the inductor 12; or when the switch 11 is turned ON, the conventional switch circuit 100 drives the LED 13 to emit light by the current discharge from the capacitor 15, and charges the inductor 12 by the input voltage V_{IN}.

As to the boost-type switch circuit 100, the forward voltage V_{F} of the LED 13 has to be larger than the maximum voltage V_{MAX} of the input voltage V_{IN}, otherwise the switch circuit 100 maybe cannot function. However, a larger forward voltage V_{F} of the LED 13 is usually obtained by a series connection, which may result in a higher cost, and the larger forward voltage V_{F} will result in difficulty in driving the LED 13 to emit light.

Alternatively, by adoption of another conventional buck converter as the switch circuit for controlling the operation of the LED, the switch circuit may function only when the input voltage V_{IN} is higher than the forward voltage V_{F} of the LED, which may limit the operating time significantly. Therefore, there is very limited application for the conventional boost-type or buck-type switch circuit.

### SUMMARY OF THE INVENTION

It is an objective of the present invention to provide a switch circuit for controlling supply of electrical energy to a load, comprising an unidirectional power source module, an inductor, a switch module and an unidirectional load module. The unidirectional power source module may rectify an AC power V_{AC} of a utility power to a pulsating DC input voltage. By controlling a switching operation of the switch module, the unidirectional load module receives an input energy modulated by the inductor. Therefore, when the input voltage, at a phase angle, has a higher potential, the switch circuit may control the operating current by the inductor's properties and may also modulate the operating power of the unidirectional load module, and when the input voltage is at a phase angle having a lower potential, the switch circuit still may store or discharge the electrical energy by switching the inductor so as to provide the operating current to the unidirectional load module.

It is an objective of the present invention to provide a switch circuit for controlling supply of electrical energy to a load, the unidirectional load module comprises a constant-voltage load element for emitting light, and the constant-voltage load element may be connected in parallel to a capacitor. In the case of too much rapid change of the current of unidirectional load module, the capacitor may average the operating current of the constant-voltage load element so as to avoid a larger fluctuation of the current of the constant-voltage load element.

It is an objective of the present invention to provide a switch circuit for controlling supply of electrical energy to a load, the switch circuit further comprises a front energy storing module. When the input voltage is at a lower potential, the front energy storing module may discharge the electrical energy to the unidirectional load module.

It is an objective of the present invention to provide a switch circuit for controlling supply of electrical energy to a load, wherein the front energy storing module comprises a front capacitor and a switch. By controlling a switching operation of the switch, a charging current and a charging time of the front capacitor may be modulated so as to improve a power factor of the circuit system.

It is an objective of the present invention to provide a switch circuit for controlling supply of electrical energy to a load, wherein the switch circuit further comprises a back energy storing module. When the input voltage is at a lower potential, the inductor or the back energy storing module is switched to discharge the stored electrical energy so as to provide the operating current to the unidirectional load module.

It is an objective of the present invention to provide a switch circuit for controlling supply of electrical energy to a load, wherein the back energy storing module comprises a back capacitor and a switch. By controlling the switching operation of the switch, the charging current and the charging time of the back capacitor may be modulated so as to improve the power factor of the circuit system.

To achieve the aforementioned objective, the present invention provides a switch circuit for controlling supply of electrical energy to a load, comprising: an unidirectional power source module having a first node and a second node; an unidirectional load module having a first node and a second node; an inductor, one terminal of the inductor being connected to the first node of the unidirectional power source module and the second node of the unidirectional load module, the other terminal of the inductor being connected to the first node of the unidirectional load module; and a switch module comprising a first switch, a first terminal of the first switch being connected to the first node of the unidirectional load module, a control terminal of the first switch being configured to receive a first control signal, and a second terminal of the first switch being connected to the second node of the unidirectional power source module, wherein the first switch is turned ON or OFF according to the first control signal.

In an embodiment of the present invention, when the first switch is turned ON, the inductor is enabled to store the electrical energy; when the first switch is turned OFF, the inductor is enabled to discharge the electrical energy to the unidirectional load module.

In an embodiment of the present invention, the switch circuit further comprises a front energy storing module, wherein the front energy storing module comprises a front capacitor, one terminal of the front capacitor is connected to the first node of the unidirectional power source module, and the other terminal of the front capacitor is connected to the second node of the unidirectional power source module.

In an embodiment of the present invention, the front energy storing module further comprises a second switch, a first terminal of the second switch is connected to the other terminal of the front capacitor, a control terminal of the second switch is configured to receive a second control signal, and a second terminal of the second switch is connected to the second node of the unidirectional power source module, and wherein the second switch is turned ON, OFF or in current limiting mode according to the second control signal.

The present invention further provides a switch circuit for controlling supply of electrical energy to a load, comprising: an unidirectional power source module having a first node and a second node; an unidirectional load module having a first node and a second node; an inductor, one terminal of the inductor being connected to the first node of the unidirectional power source module and being connected to the second node of the unidirectional load module by an unidirectional conduction element, the other terminal of the inductor being connected to the first node of the unidirectional load module; a switch module comprising a first switch, a first terminal of the first switch being connected to the second node of the unidirectional load module, a control terminal of the first switch being configured to receive a first control signal, and a second terminal of the first switch being connected to the second node of the unidirectional power source module, wherein the first switch is turned ON or OFF according to the first control signal; and a front energy storing module comprising a front capacitor and a second switch, one terminal of the front capacitor being connected to the first node of the unidirectional power source module, a first terminal of the second switch being connected to the other terminal of the front capacitor, a control terminal of the second switch being configured to receive a second control signal, and a second terminal of the second switch being connected to the second node of the unidirectional power source module, wherein the second switch is turned ON, OFF or in current limiting mode according to the second control signal.

In an embodiment of the present invention, when the first switch is turned ON, the inductor is enabled to store the electrical energy; when the first switch is turned OFF, the inductor is enabled to discharge the electrical energy to the unidirectional load module.

The present invention further provides a switch circuit for controlling supply of electrical energy to a load, comprising: an unidirectional power source module having a first node and a second node; an unidirectional load module having a first node and a second node; an inductor, one terminal of the inductor being connected to the first node of the unidirectional power source module and being connected to the second node of the unidirectional load module by a first unidirectional conduction element, the other terminal of the inductor being connected to the first node of the unidirectional load module; and a switch module comprising a first switch and a second switch, a first terminal of the first switch being connected to the first node of the unidirectional load module, a control terminal of the first switch being configured to receive a first control signal, and a second terminal of the first switch being connected to the second node of the unidirectional power source module, a first terminal of the second switch being connected to the second node of the unidirectional load module, a control terminal of the second switch being configured to receive a second control signal, and a second terminal of the second switch being connected to the second node of the unidirectional power source module, wherein the first switch is turned ON or OFF according to the first control signal, and the second switch is turned ON or OFF according to the second control signal.

In an embodiment of the present invention, the switch circuit further comprises a front energy storing module, wherein the front energy storing module comprises a front capacitor and a third switch, one terminal of the front capacitor is connected to the first node of the unidirectional power source module, a first terminal of the third switch is connected to the other terminal of the front capacitor, a control terminal of the third switch is configured to receive a third control signal, and a second terminal of the third switch is connected to the second node of the unidirectional power source module, and wherein the third switch is turned ON, OFF or in current limiting mode according to the third control signal.

The present invention further provides a switch circuit for controlling supply of electrical energy to a load, comprising: an unidirectional power source module having a first node and a second node; an unidirectional load module having a first node and a second node; an inductor, one terminal of the inductor being connected to the first node of the unidirectional power source module, the other terminal of the inductor being connected to the first node of the unidirectional load module; a switch module comprising a first switch, a first terminal of the first switch being connected to the first node or the second node of the unidirectional load module, a control terminal of the first switch being configured to receive a first control signal, and a second terminal of the first switch being connected to the second node of the unidirectional power source module, wherein the first switch is turned ON or OFF according to the first control signal; and a back energy storing module comprising a back capacitor, one terminal of the back capacitor being connected to one terminal of the inductor by a first unidirectional conduction element and being connected to the second node of the unidirectional load module by a second unidirectional conduction element, and the other terminal of the back capacitor being connected to the second node of the unidirectional power source module.

In an embodiment of the present invention, the switch module further comprises a second switch, a first terminal of the second switch is connected to the first node or the second node of the unidirectional load module, a control terminal of the second switch is configured to receive a second control signal, and a second terminal of the second switch is connected to the second node of the unidirectional power source module, and wherein the second switch is turned ON or OFF according to the second signal.

The present invention further provides a switch circuit for controlling supply of electrical energy to a load, comprising: an unidirectional power source module having a first node and a second node; an unidirectional load module having a first node and a second node; an inductor, one terminal of the inductor being connected to the first node of the unidirectional power source module, the other terminal of the inductor being connected to the first node of the unidirectional load module by a first unidirectional conduction element; a switch module comprising a first switch and a second switch, a first terminal of the first switch being connected to the other terminal of the inductor, a control terminal of the first switch being configured to receive a first control signal, and a second terminal of the first switch being connected to the second node of the unidirectional power source module, a first terminal of the second switch being connected to the second node of the unidirectional load module, a control terminal of the second switch being configured to receive a second control signal, and a second terminal of the second switch being connected to the second node of the unidirectional power source module, wherein the first switch is turned ON or OFF according to the first control signal, and the second switch is turned ON or OFF according to the second control signal.; and a back energy storing module comprising a back capacitor, one terminal of the back capacitor being connected to the first node of the unidirectional load module by a second unidirectional conduction element and being connected to the second node of the unidirectional load module by a third unidirectional conduction element, and the other terminal of the back capacitor being connected to the second node of the unidirectional power source module.

In an embodiment of the present invention, the first switch remains OFF, and the second switch performs a switching operation; or the first switch performs the switching operation, and the second switch remains OFF; or the first control signal is synchronized to the second signal with the same phase or opposite phases; or the first control signal is asynchronous to the second signal.

In an embodiment of the present invention, the back energy storing module further comprises a third switch, a first terminal of the third switch is connected to the other terminal of the back capacitor, a control terminal of the third switch is configured to receive a third control signal, and a second terminal of the third switch is connected to the second node of the unidirectional power source module, and wherein the third switch is turned ON, OFF or in current limiting mode according to the third control signal.

In an embodiment of the present invention, the unidirectional load module comprises a constant-voltage load element.

In an embodiment of the present invention, the constant-voltage load element has a first node and a second node, the first node of the constant-voltage load element is connected to the first node of the unidirectional load module by an unidirectional conduction load element, or the second node of the constant-voltage load element is connected to the second node of the unidirectional load module by the unidirectional conduction load element.

In an embodiment of the present invention, the unidirectional load module further comprises a load capacitor; the load capacitor is connected in parallel to the constant-voltage load element.

### BRIEF DESCRIPTION OF THE DRAWINGS

FIG. 1 shows a schematic diagram of a conventional switch circuit.

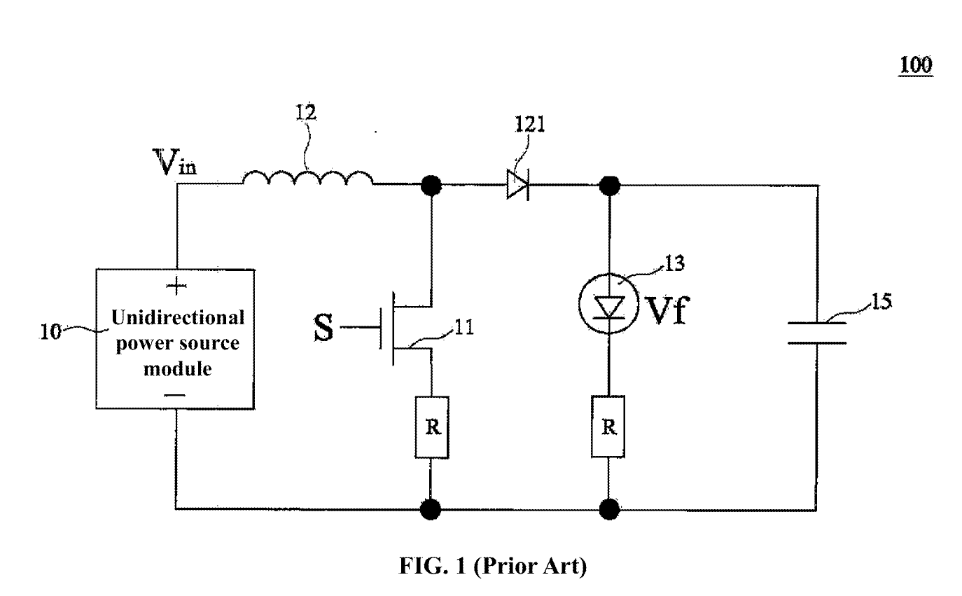

FIG. 2 shows a schematic block diagram of an embodiment of the switch circuit in accordance with the present invention.

FIG. 3A shows a schematic diagram of an embodiment of the switch circuit of FIG. 2 in accordance with the present invention.

FIG. 3B shows a schematic diagram of another embodiment of the switch circuit of FIG. 2 in accordance with the present invention.

FIG. 3C shows a schematic diagram of another embodiment of the switch circuit of FIG. 2 in accordance with the present invention.

FIG. 4 shows a schematic block diagram of another embodiment of the switch circuit in accordance with the present invention.

FIG. 5 shows a schematic diagram of an embodiment of the switch circuit of FIG. 4 in accordance with the present invention.

FIG. 6 shows a schematic block diagram of another embodiment of the switch circuit in accordance with the present invention.

FIG. 7A shows a schematic diagram of an embodiment of the switch circuit of FIG. 6 in accordance with the present invention.

FIG. 7B shows a schematic diagram of another embodiment of the switch circuit of FIG. 6 in accordance with the present invention.

FIG. 8 shows a schematic block diagram of another embodiment of the switch circuit in accordance with the present invention.

FIG. 9A shows a schematic diagram of an embodiment of the switch circuit of FIG. 8 in accordance with the present invention.

FIG. 9B shows a schematic diagram of another embodiment of the switch circuit of FIG. 8 in accordance with the present invention.

FIG. 9C shows a schematic diagram of another embodiment of the switch circuit of FIG. 8 in accordance with the present invention.

FIG. 10 shows a schematic block diagram of another embodiment of the switch circuit in accordance with the present invention.

FIG. 11 shows a schematic diagram of an embodiment of the switch circuit of FIG. 10 in accordance with the present invention.

FIG. 12 shows a schematic block diagram of another embodiment of the switch circuit in accordance with the present invention.

FIG. 13A shows a schematic diagram of an embodiment of the switch circuit of FIG. 12 in accordance with the present invention.

FIG. 13B shows a schematic diagram of another embodiment of the switch circuit of FIG. 12 in accordance with the present invention.

FIG. 13C shows a schematic diagram of another embodiment of the switch circuit of FIG. 12 in accordance with the present invention.

FIG. 14 shows a schematic block diagram of another embodiment of the switch circuit in accordance with the present invention.

FIG. 15 shows a schematic diagram of an embodiment of the switch circuit of FIG. 14 in accordance with the present invention.

### DESCRIPTION OF THE PREFERRED EMBODIMENTS

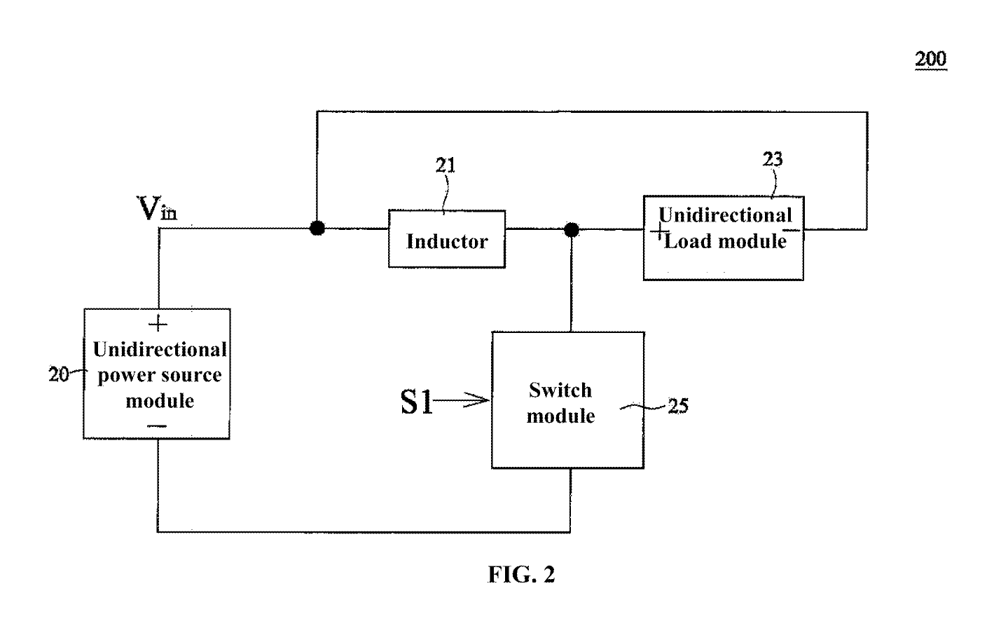

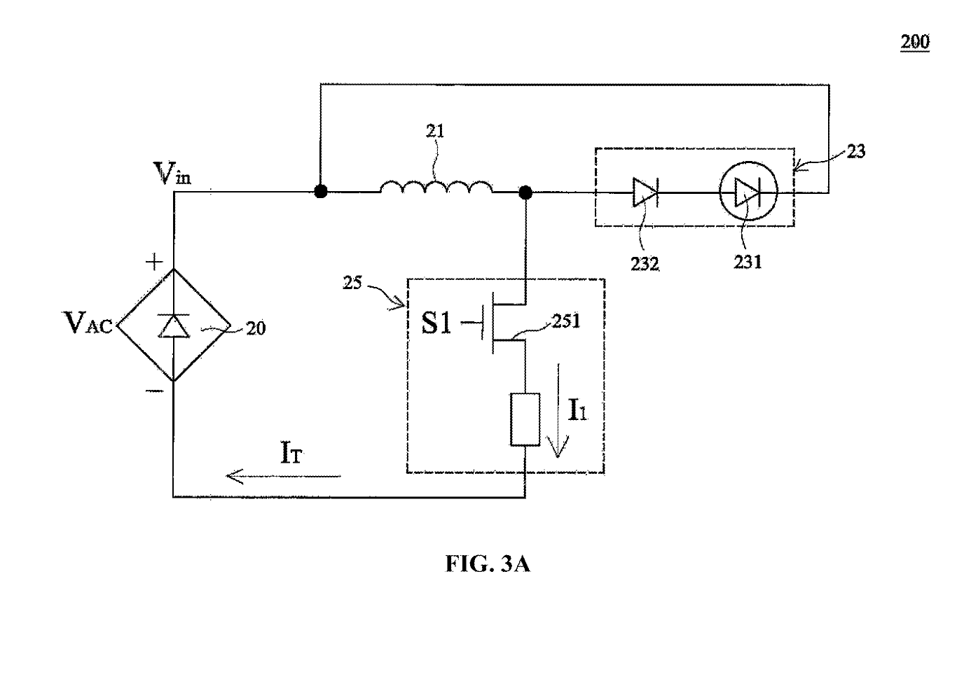

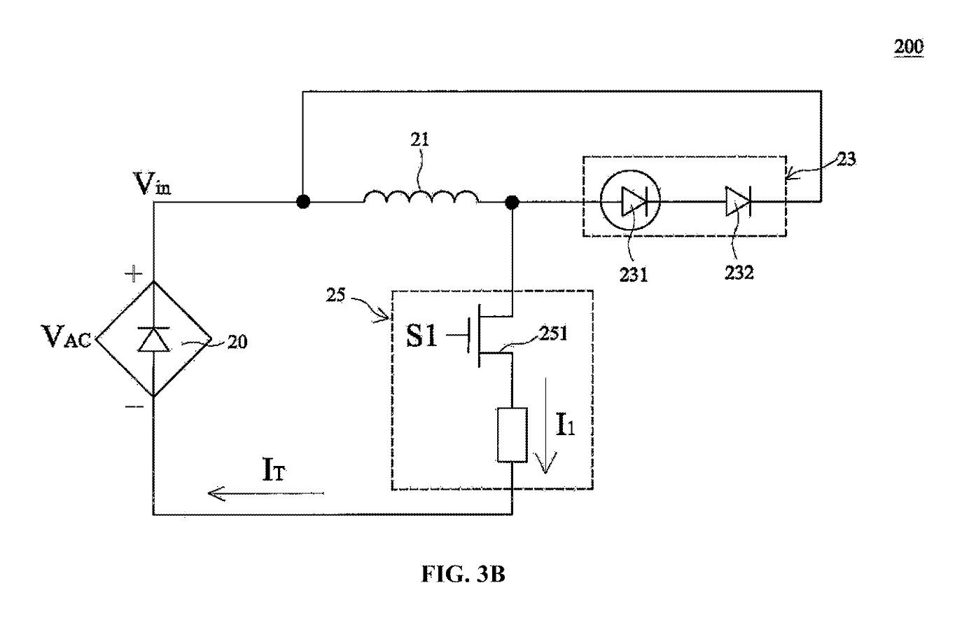

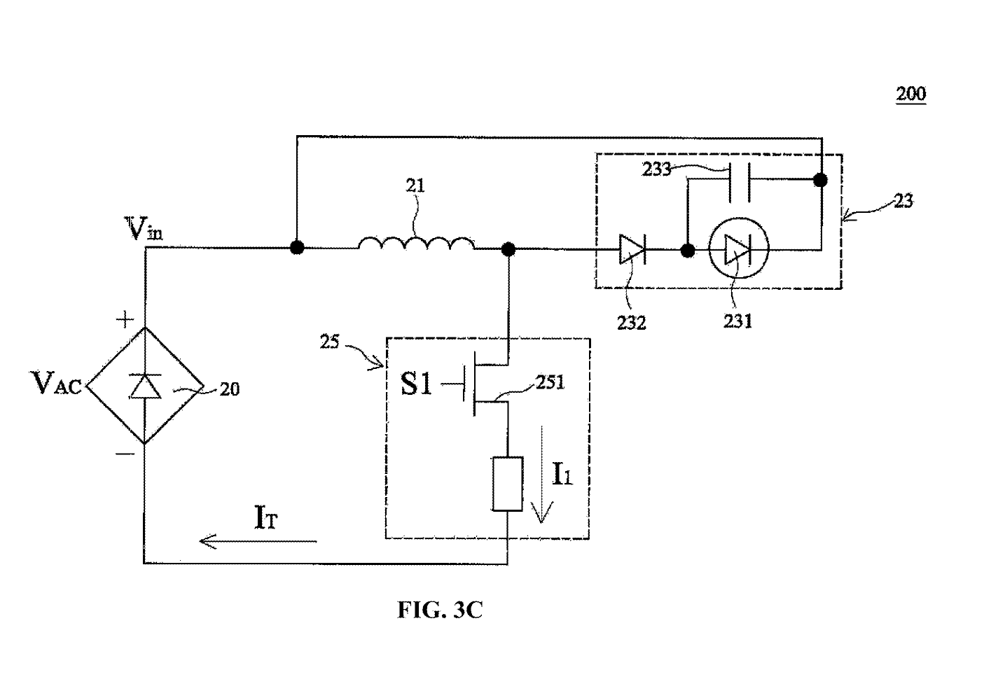

With reference to FIGS. 2 and 3A, which show a schematic block diagram and a schematic diagram of an embodiment of the switch circuit in accordance with the present invention. The switch circuit 200 comprises an unidirectional power source module 20, an inductor 21, an unidirectional load module 23 and a switch module 25.

The unidirectional power source module 20 having a first node (e.g., anode +) and a second node (e.g., cathode −) may be a bridge rectifier, which may rectify an alternating current (AC) power V_{AC} of a utility power to a pulsating direct current (DC) input voltage V_{IN}. The unidirectional load module 23 also has a first node and a second node. One terminal of the inductor 21 is connected to the first node of the unidirectional power source module 20 and the second node of the unidirectional load module 23, the other terminal of the inductor 21 is connected to the first node of the unidirectional load module 23. The switch module 25 comprises a first switch 251. A first terminal (e.g., drain) of the first switch 251 (e.g., Metal-Oxide-Semiconductor Field-Effect Transistor, MOSFET) is connected to the first node of the unidirectional load module 23, a control terminal (e.g., gate) of the first switch 251 is configured to receive a first control signal S1, and a second terminal (e.g., source) of the first switch 251 is connected to the second node of the unidirectional power source module 20. The first switch 251 is turned ON or OFF according to the first control signal S1.

The unidirectional load module 23 having a first node and a second node comprises a constant-voltage load element 231. In an embodiment of the present invention, the constant-voltage load element 231 may be a single Light-Emitting Diode (LED) or a plurality of LEDs. In another embodiment of the present invention, the constant-voltage load element 231 may be a rechargeable battery. In addition, the following description is based on using the LED as a main component of the unidirectional load. However, it will be understood by a person having ordinary skill in the art, that the main component of the unidirectional load may also be a rechargeable battery or other elements having a constant-voltage characteristics.

The switch module 25 of the present embodiment provides various methods for controlling the switch, e.g., inspecting whether a sensing current I1 of the switch module 25 exceed a predetermined value; turning OFF the first switch 251 when the sensing current I1 exceed the predetermined value, and turning ON the first switch 251 again after a delay time; or switching the first switch 251 at a regular frequency or a regular time (e.g., turning ON or OFF the first switch 251 at a regular frequency or a regular time). In addition, when the first switch 251 is turned ON, the inductor 21 is enabled to store the electrical energy by the input voltage V_{IN}; and when the first switch 251 is turned OFF, the inductor 21 is enabled to discharge the electrical energy to the unidirectional load module 23.

Besides, with reference to FIG. 3A, the unidirectional load module 23 further comprises an unidirectional conduction element 232 (e.g., a diode having a characteristics of a high reverse breakdown voltage, fast recovery, etc.). A first node of the constant-voltage load element 231 may be connected to the first node of the unidirectional load module 23 by an unidirectional conduction load element 232. Alternatively, with reference to FIG. 3B, a second node of the constant-voltage load element 231 may be connected to the second node of the unidirectional load module 23 by the unidirectional conduction load element 232.

Besides, with reference to FIG. 3C, the unidirectional load module 23 further comprises a load capacitor 233, the load capacitor 233 is connected in parallel to the constant-voltage load element 231. The load capacitor 233 and the constant-voltage load element 231 may share the current discharged from the inductor 21, e.g., I_{L}=I_{LED}+I_{C}, and the load capacitor 233 performs storing the electrical energy. Therefore, when the first switch 251 is turned ON, a part of the electrical energy stored in the load capacitor 233 may be discharged to the constant-voltage load element 231, and the load capacitor 233 still functions, so that only not the too much rapid change of the current of unidirectional load module 231 may be decreased, but also the chance of a high frequency intermittence may be reduced. As a result, the efficiency and utilization of the constant-voltage load element 231 may be improved.

In another embodiment of the present invention, the switch module 25 may further set a charging time that the load capacitor 233 is charged to a predetermined voltage and the switch module 25 uses the charging time to switch the first switch 251 at a regular time. Therefore, by turning ON or OFF the switch module 25, the inductor 21 and the load capacitor 233 may be controlled to store or discharge the electrical energy. As a result, the switch circuit 200 may function for any phase angle that the input voltage V_{IN} is at, and may control the current provided to the unidirectional load module 23 above a predetermined level.

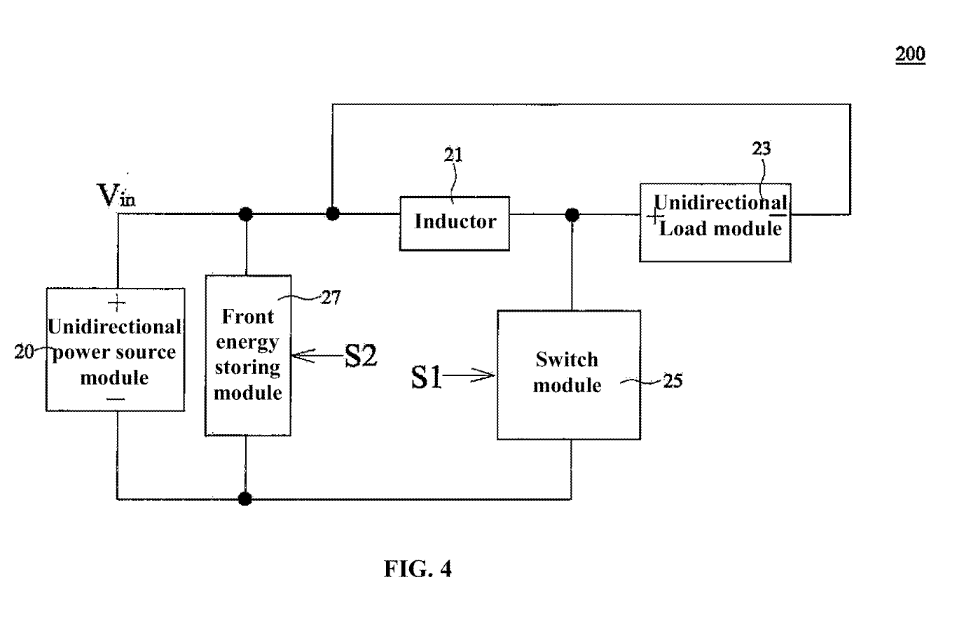

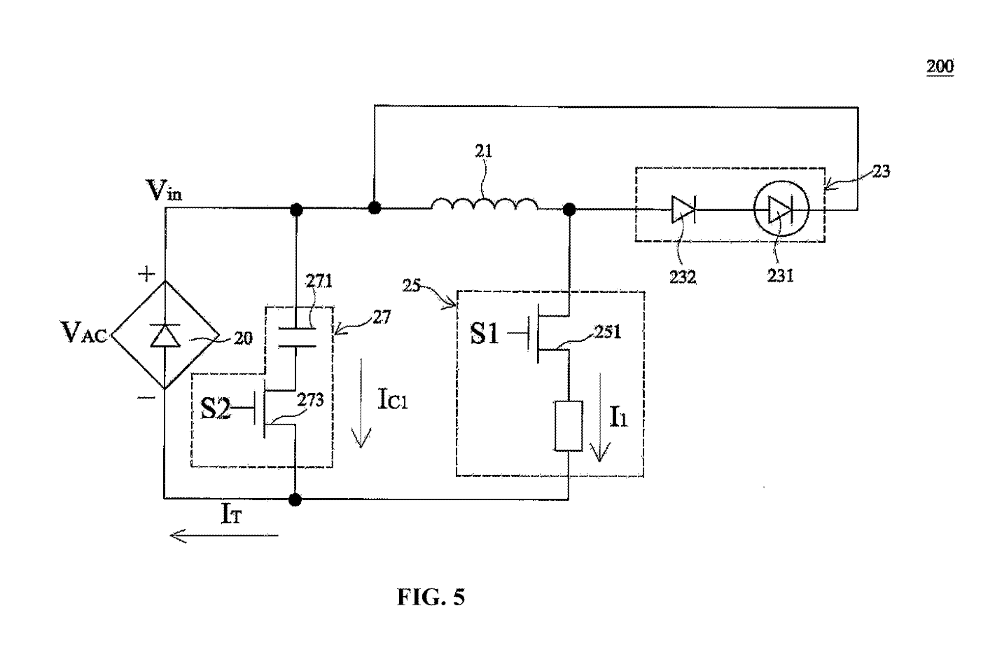

With reference to FIGS. 4 and 5, which show a schematic block diagram and a schematic diagram of another embodiment of the switch circuit in accordance with the present invention. The switch circuit 200 of the present embodiment further comprises a front energy storing module 27. The front energy storing module 27 comprises a front capacitor 271 and a second switch 273. One terminal of the front capacitor 271 is connected to the first node of the unidirectional power source module 20. A first terminal of the second switch 273 is connected to the other terminal of the front capacitor 271, a control terminal of the second switch 273 is configured to receive a second control signal S2, and a second terminal of the second switch 273 is connected to the second node of the unidirectional power source module 20.

When the input voltage V_{IN}, at a phase angle, has a higher potential, the input voltage V_{IN} charges the front capacitor 271. When the input voltage V_{IN}, is at a phase angle, has a lower potential, the electrical energy stored in the front capacitor 271 may be discharged to the unidirectional load module 23 so as to drive the constant-voltage load element 231 to emit light.

In addition, when the input voltage V_{IN} charges the front capacitor 271 at a higher potential, the front capacitor 271 will be charged rapidly by receiving a larger charging current. As a result, the power factor (PF) of the circuit system decreases. In the present embodiment, a second switch 273 is further connected in series between the front capacitor 271 and the unidirectional power source module 20 in order to improve the effect of the power factor during charging and discharging procedure of the front capacitor 271. Therefore, by turning ON or OFF the second switch 273 or controlling the current of the second switch 273, a charging current and a charging time and timing of the front capacitor 273 may be modulated so as to control a charging voltage of the front capacitor 271 and improve the power factor of the entire circuit system. In addition, by limiting the charging current of the front capacitor, the capacitance of the front capacitor may be reduced so as to reduce its volume and the cost.

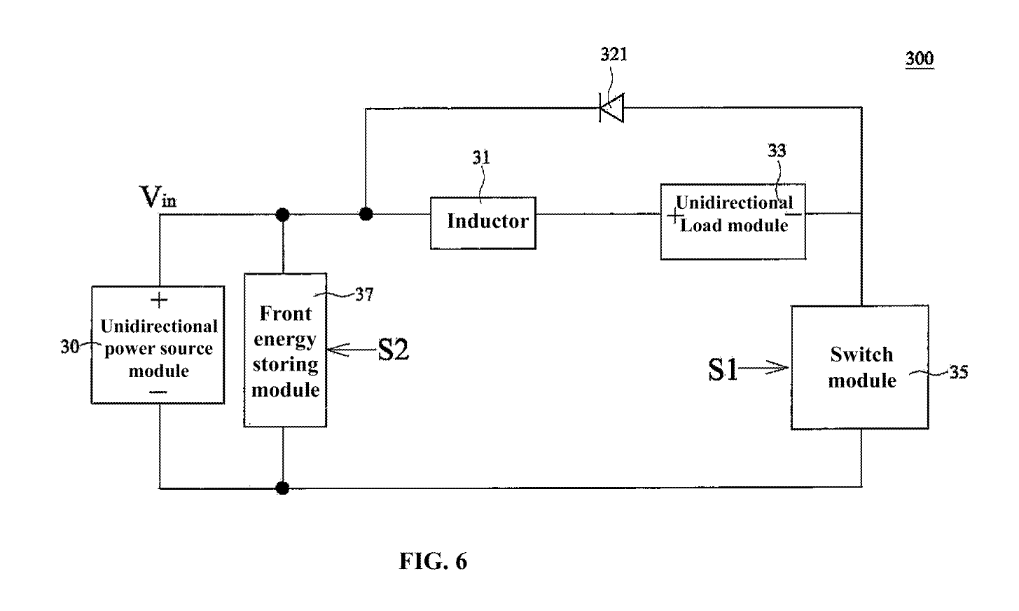

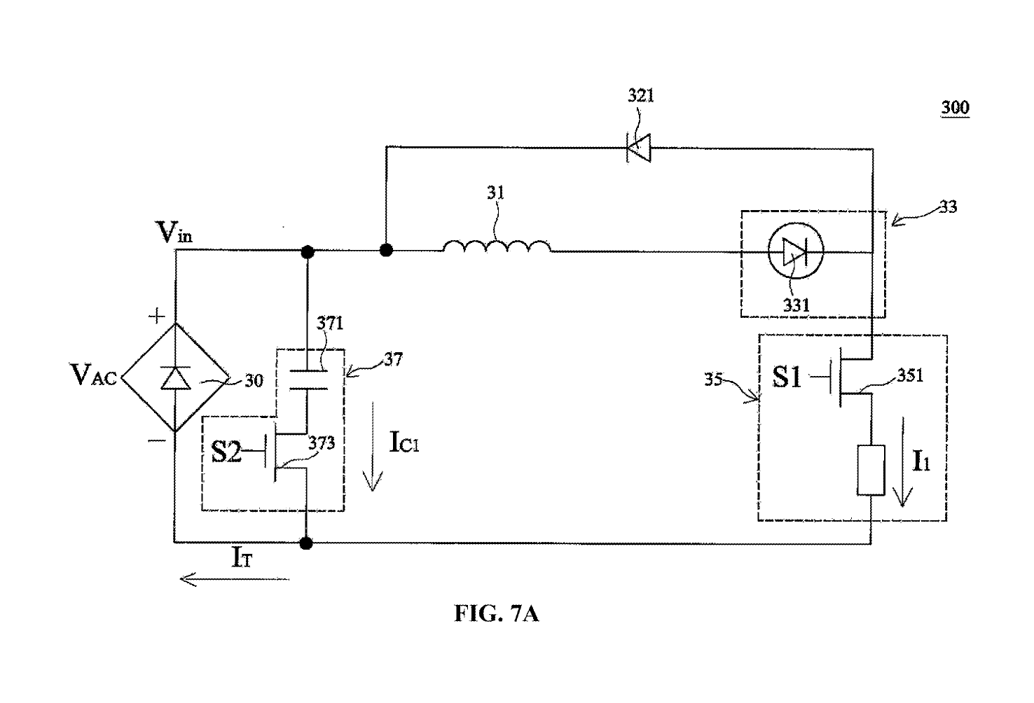

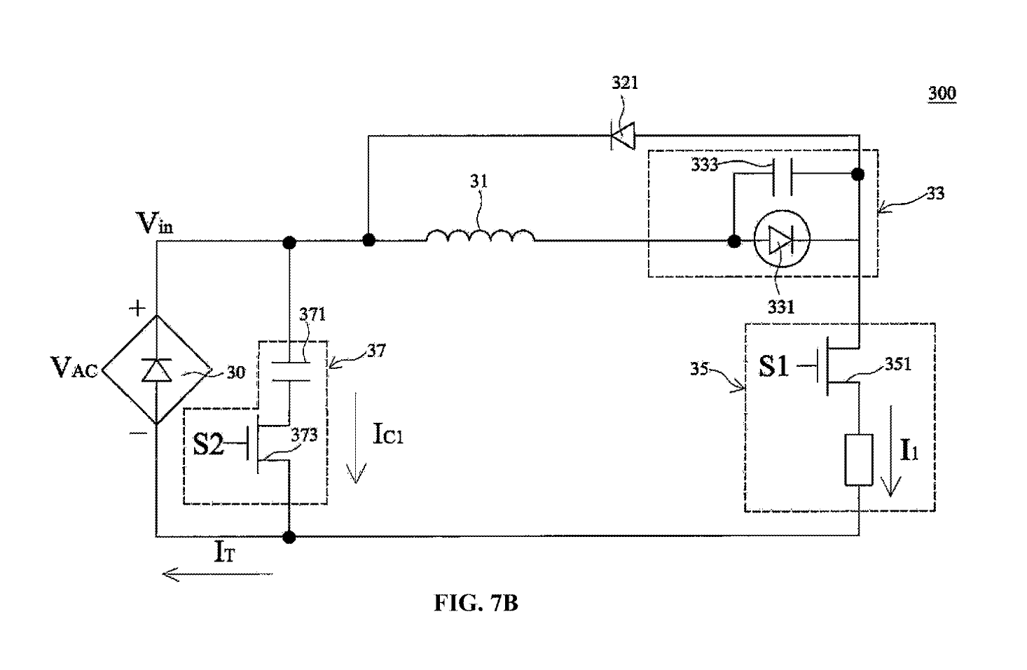

With reference to FIGS. 6 and 7A, which show a schematic block diagram and a schematic diagram of another embodiment of the switch circuit in accordance with the present invention. The switch circuit 300 of the present embodiment comprises an unidirectional power source module 30, an inductor 31, an unidirectional load module 33 and a switch module 35.

The unidirectional power source module 30 converts an AC power V_{AC} to an input voltage V_{IN}. One terminal of the inductor 31 is connected to the first node of the unidirectional power source module 30 and connected to the second node of the unidirectional load module 33 by an unidirectional conduction element 321; the other terminal of the inductor 31 is connected to the first node of the unidirectional load module 33. The switch module 35 comprises a first switch 351. A first terminal of the first switch 351 is connected to the second node of the unidirectional load module 33, a control terminal of the first switch 351 is configured to receive a first control signal S1, and a second terminal of the first switch 351 is connected to the second node of the unidirectional power source module 30, wherein the first switch 351 is turned ON or OFF according to the first control signal S1.

The switch module 35 of the present embodiment provides various methods for controlling the switch, e.g., inspecting whether a sensing current I1 of the switch module 35 exceed a predetermined value; turning OFF the first switch 351 when the sensing current I1 exceed the predetermined value, and turning ON the first switch 351 again after a delay time; or switching the first switch 351 at a regular frequency or a regular time (e.g., turning ON or OFF the first switch 351 at a regular frequency or a regular time). In addition, when the first switch 351 is turned ON, the input voltage V_{IN} charges the inductor 31 with the electrical energy and provides the electrical energy to the unidirectional load module 33; and when the first switch 351 is turned OFF, the electrical energy stored in the inductor 31 may be discharged to the unidirectional load module 23. Similarly, the switch circuit 300 of the present embodiment further comprises a front energy storing module 37. The front energy storing module 37 comprises a front capacitor 371 and a second switch 373 connected in series thereto. When the input voltage V_{IN} is smaller than that of front capacitor 371, the unidirectional power source module 30 will be replaced by the front capacitor 371 for providing the electrical energy that functions the circuit. Besides, in the charging procedure of the front capacitor 371, by controlling the second signal S2 to switch the second switch 373, charging current and charging time of the front capacitor 371 may be modulated so as to improve the power factor of the entire circuit system. In addition, by limiting the charging current of the front capacitor 371, the capacitance of the front capacitor 371 may be reduced so as to reduce its volume and the cost.

In addition, in an embodiment of the present invention, a charging/discharging factor of the front capacitor 371 may be considered, so that a predetermined value of the sensing current I1 and a delay time for turning ON may be set with different setting so as to precisely control the switching operation of the first switch 351 and then optimize the operation.

Similarly, with reference to FIG. 7A, the unidirectional load module 33 comprises a constant-voltage load element 331. Further, with reference to FIG. 7B, the constant-voltage load element 331 may be connected in parallel to a load capacitor 333 so as to reduce too much rapid change of the current of constant-voltage load element 331. In addition, in another embodiment of the present invention, the switch module 35 may further set a charging time that the load capacitor 333 is charged to a predetermined voltage so as to use the charging time to switch the first switch 251 at a regular time.

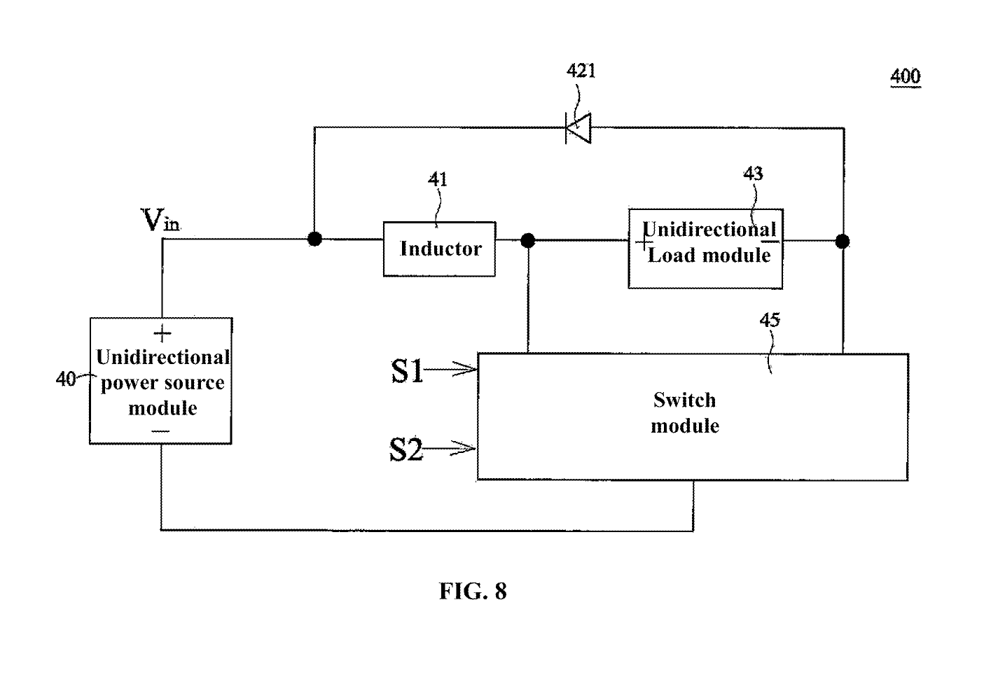

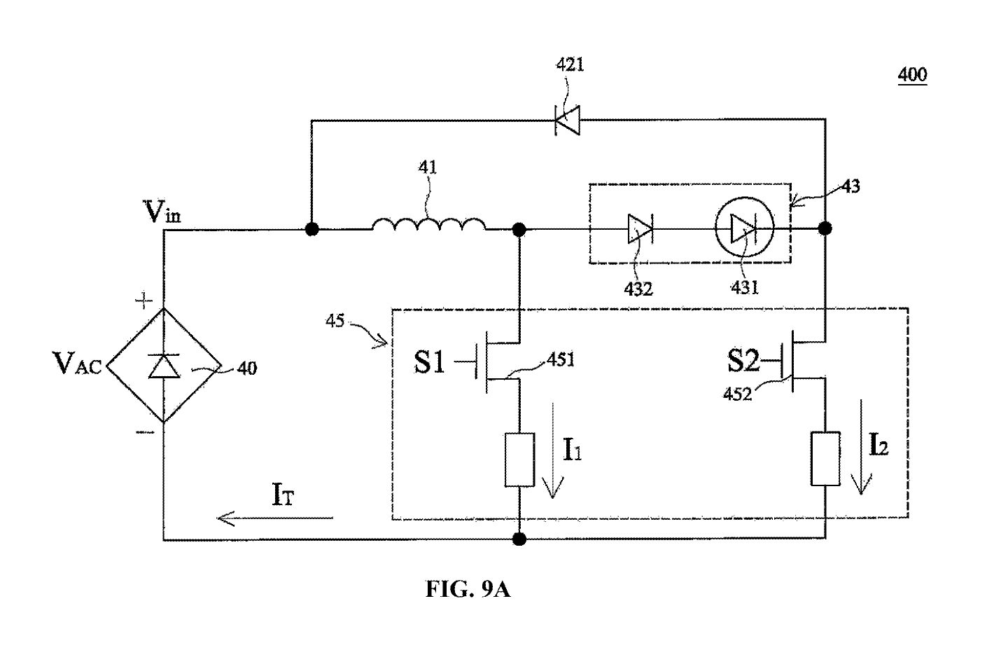

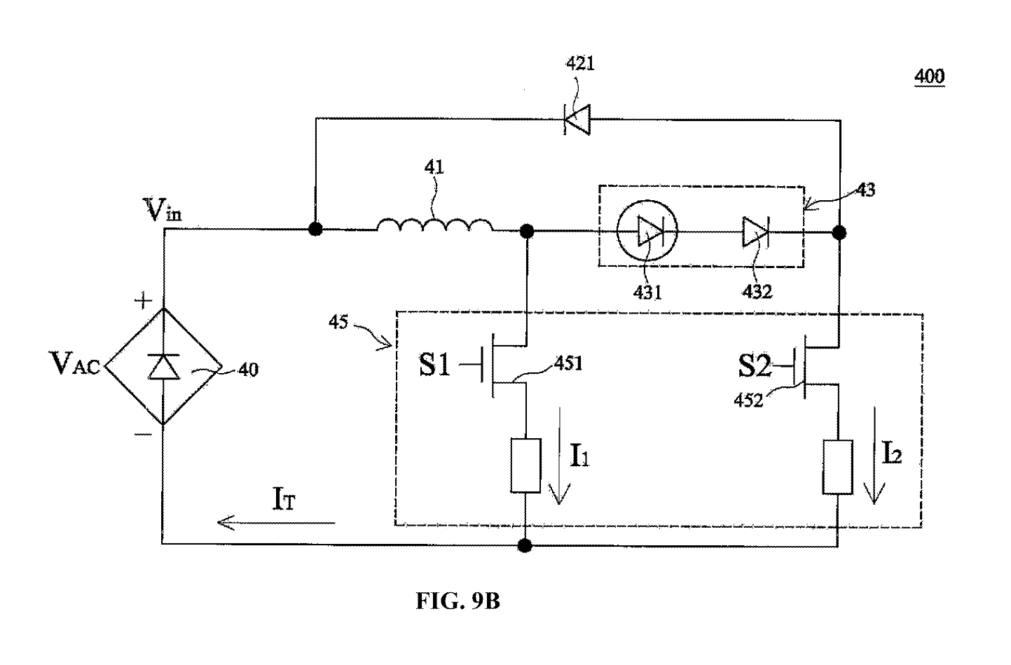

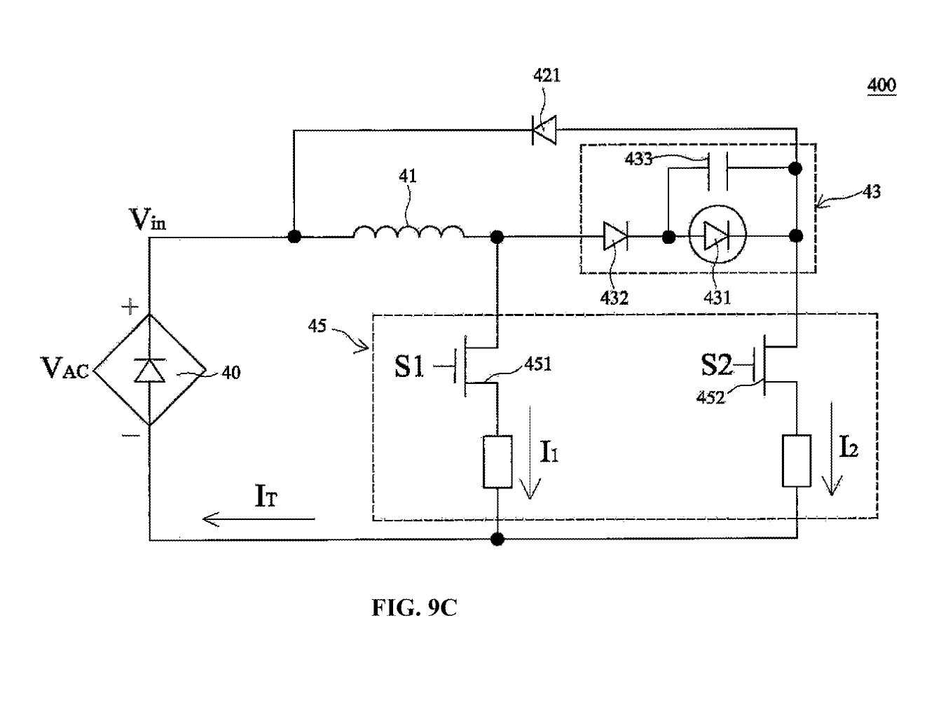

With reference to FIGS. 8 and 9A, which show a schematic block diagram and a schematic diagram of another embodiment of the switch circuit in accordance with the present invention. The switch circuit 400 of the present embodiment comprises an unidirectional power source module 40, an inductor 41, an unidirectional load module 43 and a switch module 45.

The unidirectional power source module 40 converts an AC power V_{AC} to an input voltage V_{IN}. One terminal of the inductor 31 is connected to the first node of the unidirectional power source module 40 and connected to the second node of the unidirectional load module 43 by a first unidirectional conduction element 421; the other terminal of the inductor 41 is connected to the first node of the unidirectional load module 43. The switch module 45 comprises a first switch 451 and a second switch 452. A first terminal of the first switch 451 is connected to the first node of the unidirectional load module 43, a control terminal of the first switch 451 is configured to receive a first control signal S1, and a second terminal of the first switch 451 is connected to the second node of the unidirectional power source module 40. A first terminal of the second switch 452 is connected to the second node of the unidirectional load module 43, a control terminal of the second switch 452 is configured to receive a second control signal S2, and a second terminal of the second switch 452 is connected to the second node of the unidirectional power source module 40. Wherein, the first switch 451 is turned ON or OFF according to the first control signal S1, and the second switch 452 is turned ON or OFF according to the second control signal S2.

In a method for controlling the switch module 45 in accordance with the present embodiment, when the input voltage V_{IN}, at a phase angle, has a higher potential, the first switch 451 is turned OFF by the first control signal S1, and the second control signal S2 controls a switching operation of the second switch 452 or controls a switching operation of the second switch 452 with a regular time according to the value of the sensing current I2, a delay time for tuning ON, etc. In the meantime, the input voltage V_{IN} provides the electrical energy to the unidirectional load module 43 (e.g., turning ON or OFF the second switch 452) or stores the electrical energy in the inductor 41 (e.g., turning ON the second switch 452). On the contrary, when the input voltage V_{IN}, at a phase angle, has a lower potential, the second switch 452 is turned OFF by the second control signal S2, and the first control signal S1 controls a switching operation of the first switch 451 or controls a switching operation of the first switch 451 with a regular time according to the value of the sensing current I1, a delay time for tuning ON, etc. In the meantime, the input voltage V_{IN} charges the inductor 41 with the electrical energy (e.g., turning ON the first switch 451) or discharges the electrical energy stored in the inductor 41 to the unidirectional load module 43 (e.g., turning OFF the first switch 451).

The aforementioned method for controlling the switch module 45 is just an embodiment in accordance of the present invention. Herein, the first control signal S1 synchronized to the second signal S2 with the same phase or opposite phases, or the first control signal S1 asynchronous to the second signal S2 for controlling the switching operation of the switch module 45 could be made thereto by those skilled in the art without departing from the scope and spirit of the switch circuit 400.

Similarly, with reference to FIG. 9A, the unidirectional load module 43 comprises a constant-voltage load element 431. Further, with reference to FIG. 9B, a second node or a first node of the constant-voltage load element 431 may be connected to the second node or the first node of the unidirectional load module 43 by an unidirectional conduction load element 432. Alternatively, with reference to FIG. 9C, the constant-voltage load element 431 is connected in parallel to a load capacitor 433 so as to reduce too much rapid change of the current of constant-voltage load element 431.

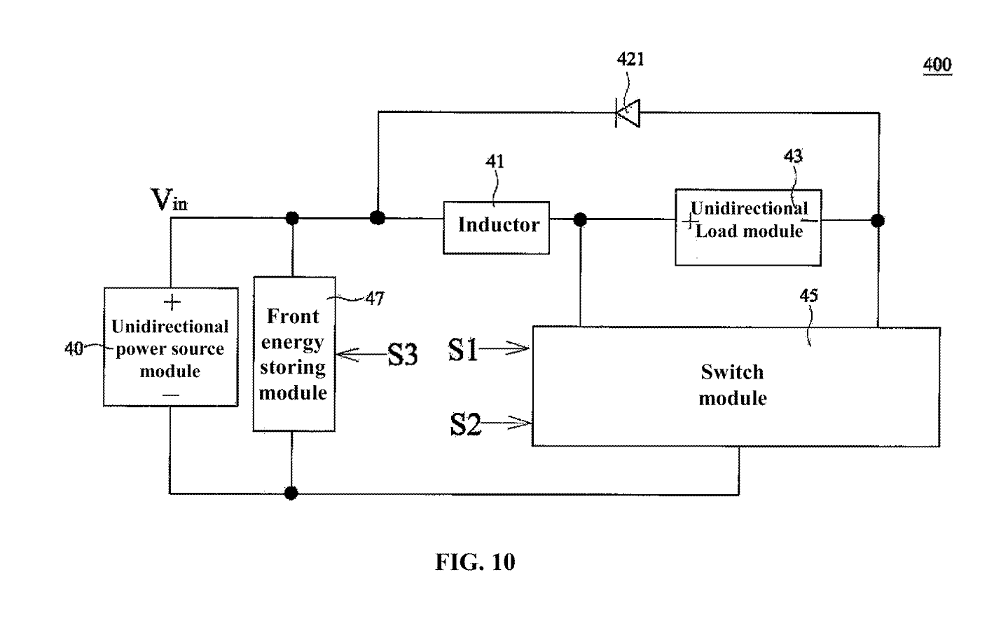

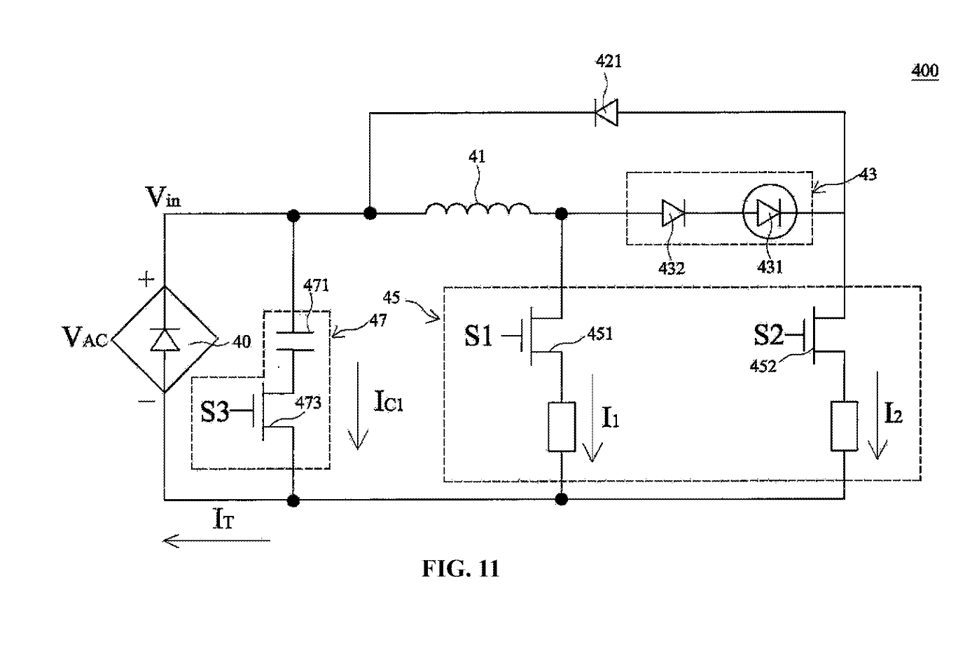

Similarly, with further reference to FIGS. 10 and 11, the switch circuit 400 may comprises a front energy storing module 47. The front energy storing module 47 comprises a front capacitor 471 and a third switch 473 connected in parallel thereto. When the input voltage V_{IN}, at a phase angle, is smaller than that of front capacitor 471, the unidirectional power source module 40 will be replaced by the front capacitor 471 for providing the electrical energy that functions the circuit. Besides, in the charging procedure of the front capacitor 471, by controlling a third signal S3 to switch the third switch 473, charging current and charging time of the front capacitor 471 may be modulated so as to improve the power factor of the entire circuit system. In addition, by limiting the charging current of the front capacitor 471, the capacitance of the front capacitor 471 may be reduced so as to reduce its volume and the cost. In addition, in an embodiment of the present invention, a charging/discharging factor of the front capacitor 471 may be considered, so that a predetermined value of the sensing current I1, I2 and a delay time for turning ON may be set with different setting so as to precisely control the switching operation of the first switch 451 and the second switch 452 and then optimize the operation.

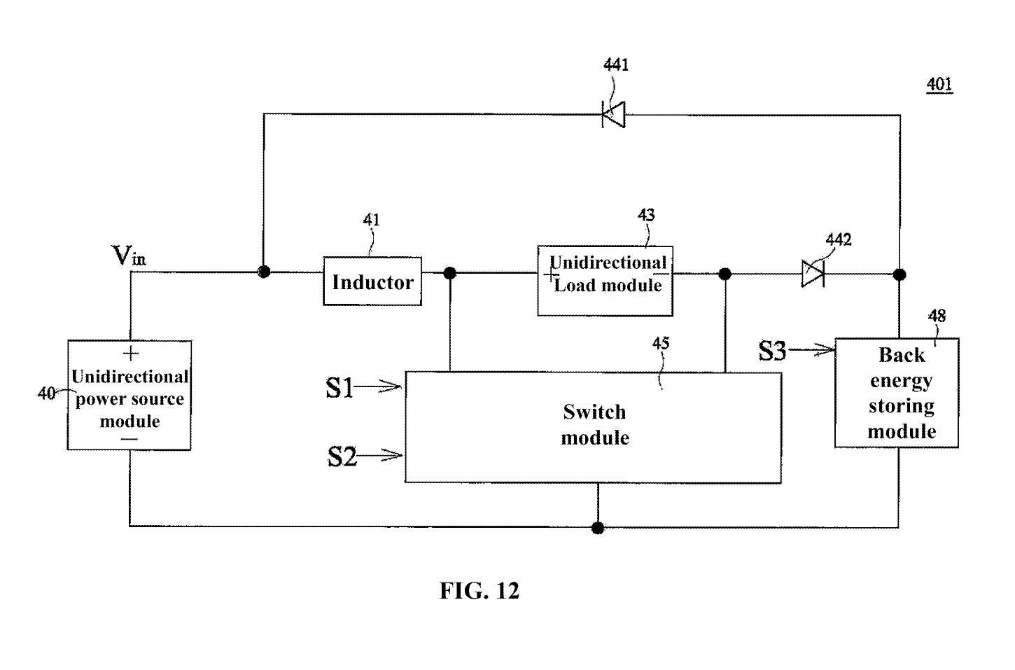

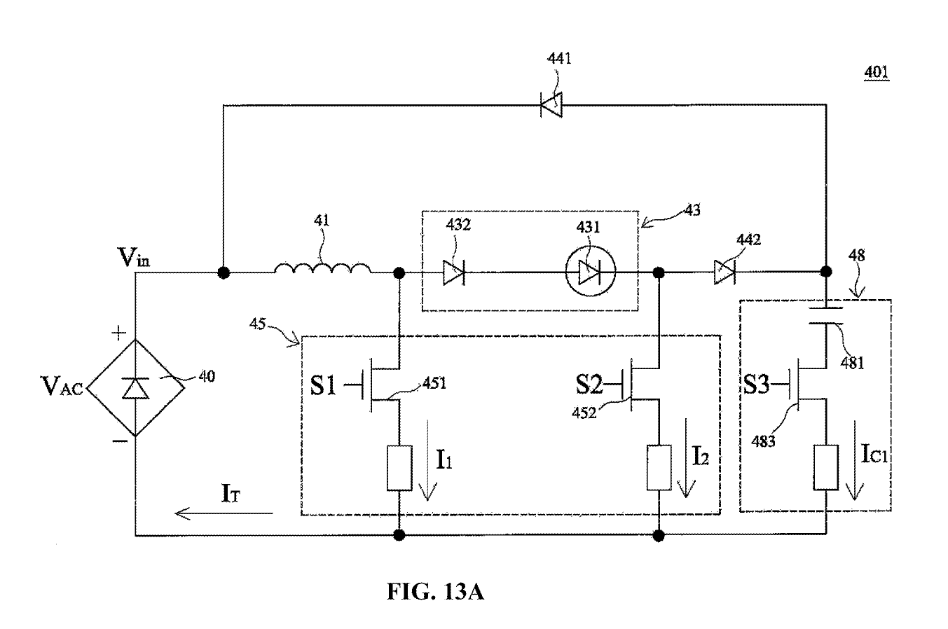

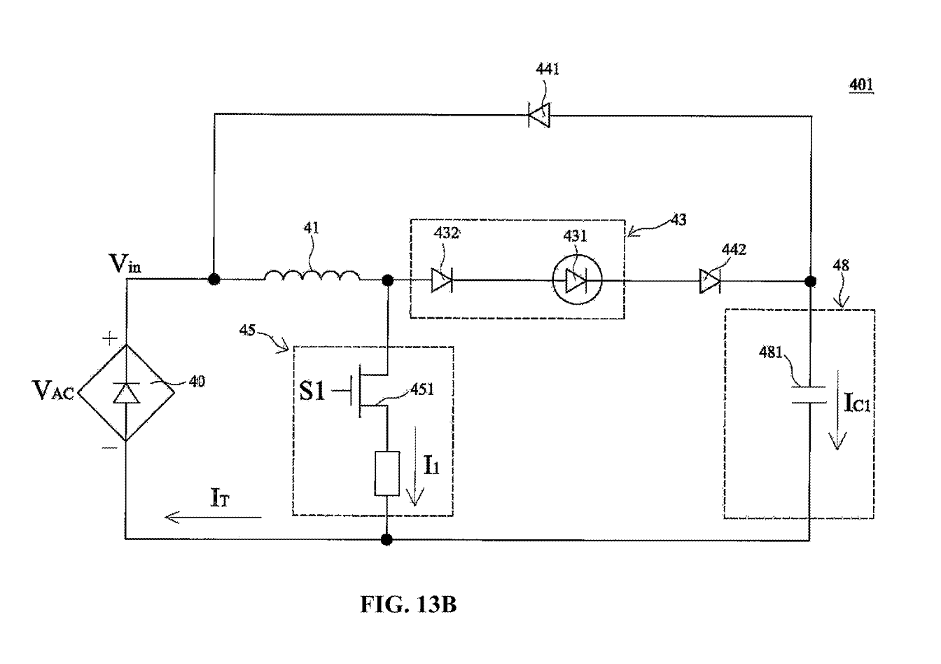

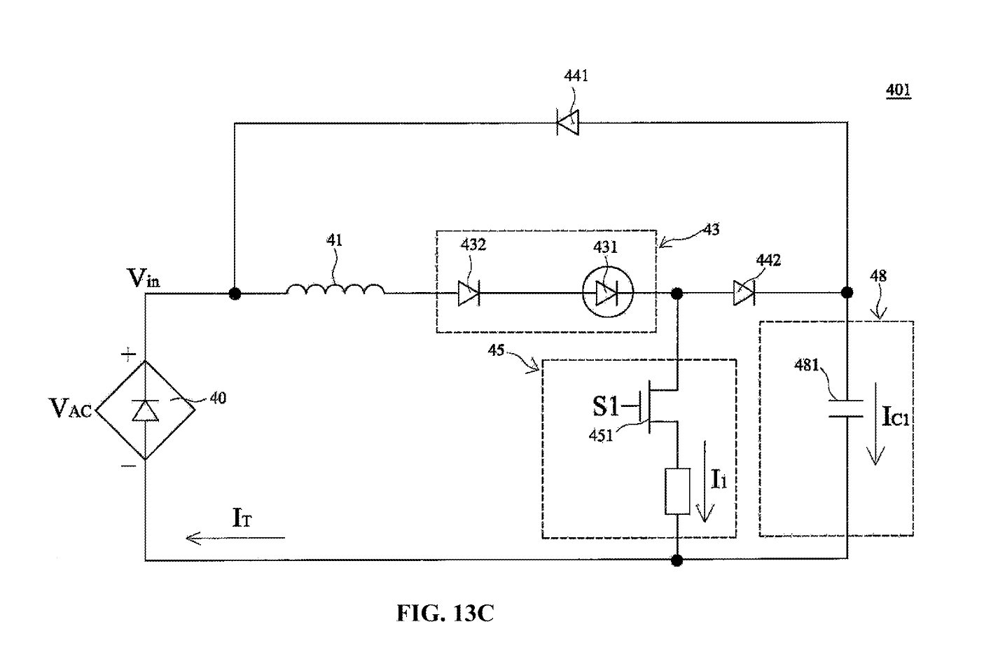

With reference to FIGS. 12 and 13A, which show a schematic block diagram and a schematic diagram of another embodiment of the switch circuit in accordance with the present invention. The switch circuit 401 of the present embodiment compared to that of FIGS. 8 and 9A further comprises a back energy storing module 48.

The back energy storing module 48 comprises a back capacitor 481, one terminal of the back capacitor 481 is connected to one terminal of the inductor 41 by a first unidirectional conduction element 441 and connected to the second node of the unidirectional load module 43 by a second unidirectional conduction element 442, and the other terminal of the back capacitor 481 is connected to the second node of the unidirectional power source module 40.

When the input voltage V_{IN}, at a phase angle, has a higher potential, the first switch 451 is turned OFF, and the second switch 452 performs a switching operation. When the second switch 452 is turned ON, the input voltage V_{IN} charges the inductor 41 with the electrical energy, the sensing current I2 flows through the unidirectional load module 43 (emitting light) and rises continuously. Later on, when the sensing current I2 exceeds a predetermined value, the second switch 452 is turned OFF. If the input voltage V_{IN} is larger than a potential of the electrical energy stored in the back capacitor 481, the current discharged from the inductor 41 flows through the unidirectional load module 43 (emitting light) and the back capacitor 481 (charging) and then flows back to the second node of the unidirectional power source module 40 so as to form a loop; If the input voltage V_{IN} is smaller than a potential of the electrical energy stored in the back capacitor 481, the unidirectional power source module 40 will be replaced by the back capacitor 481 for providing the electrical energy that functions the circuit, and the current discharged from the inductor 41 flows through the unidirectional load module 43 (emitting light) and the first unidirectional conduction element 441 and then flows back to a terminal of the inductor 41 so as to form a loop.

When the input voltage V_{IN}, at a phase angle, has a lower potential, the second switch 452 is turned OFF, and the first switch 451 performs a switching operation. When the first switch 451 is turned ON, the input voltage V_{IN} charges the inductor 41 with the electrical energy, and the sensing current I1 rises continuously. Later on, when the sensing current I1 exceeds a predetermined value, the first switch 451 is turned OFF. If the input voltage V_{IN} is larger than a potential of the electrical energy stored in the back capacitor 481, the current discharged from the inductor 41 flows through the unidirectional load module 43 (emitting light) and the back capacitor 481 (charging) and then flows back to the second node of the unidirectional power source module 40 so as to form a loop; If the input voltage V_{IN} is smaller than a potential of the electrical energy stored in the back capacitor 481, the unidirectional power source module 40 will be replaced by the back capacitor 481 for providing the electrical energy that functions the circuit, and the current discharged from the inductor 41 flows through the unidirectional load module 43 (emitting light) and the first unidirectional conduction element 441 and then flows back to a terminal of the inductor 41 so as to form a loop.

In addition, in an embodiment of the present invention, the back energy storing module 48 further comprises a third switch 483. A first terminal of the third switch 483 is connected to the other terminal of the back capacitor 481, a control terminal of the third switch 481 is configured to receive a third control signal S3, and a second terminal of the third switch 481 is connected to the second node of the unidirectional power source module 40. In the charging procedure of the back capacitor 481, by controlling the third signal S3 to switch the third switch 483, charging current and charging time of the back capacitor 481 may be modulated so as to improve the power factor of the entire circuit system. In addition, by limiting the charging current of the back capacitor 481, the capacitance of the back capacitor 481 may be reduced so as to reduce its volume and the cost.

Besides, in another embodiment of the present invention, the switch module 45 only has a single switch (e.g., the first switch 451). As FIG. 13B shows, the single switch 451 is connected between the first node of the unidirectional load module 43 and the second node of the unidirectional power source module 40; alternatively, as FIG. 13C shows, the single switch 451 is connected between the second node of the unidirectional load module 43 and the second node of the unidirectional power source module 40. Therefore, by controlling the switching operation of the single switch 451, charging or discharging the inductor 41 with the electrical energy may also be determined. In addition, when the input voltage V_{IN}, at a phase angle, has a lower potential, the back capacitor 481 may be charged or discharged by switching the back capacitor 481 so as to replace the unidirectional power source module for providing the electrical energy that functions the circuit.

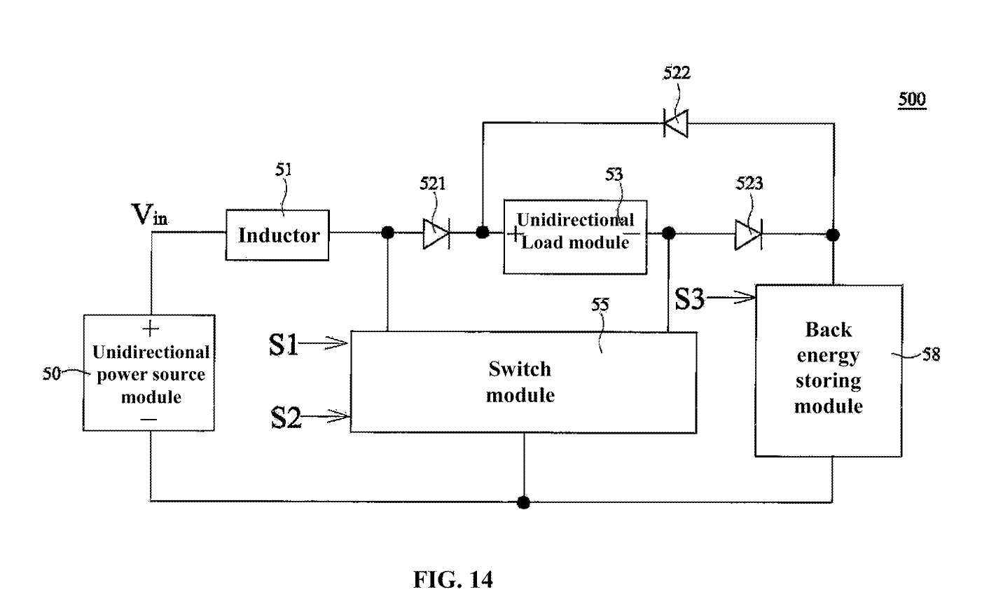

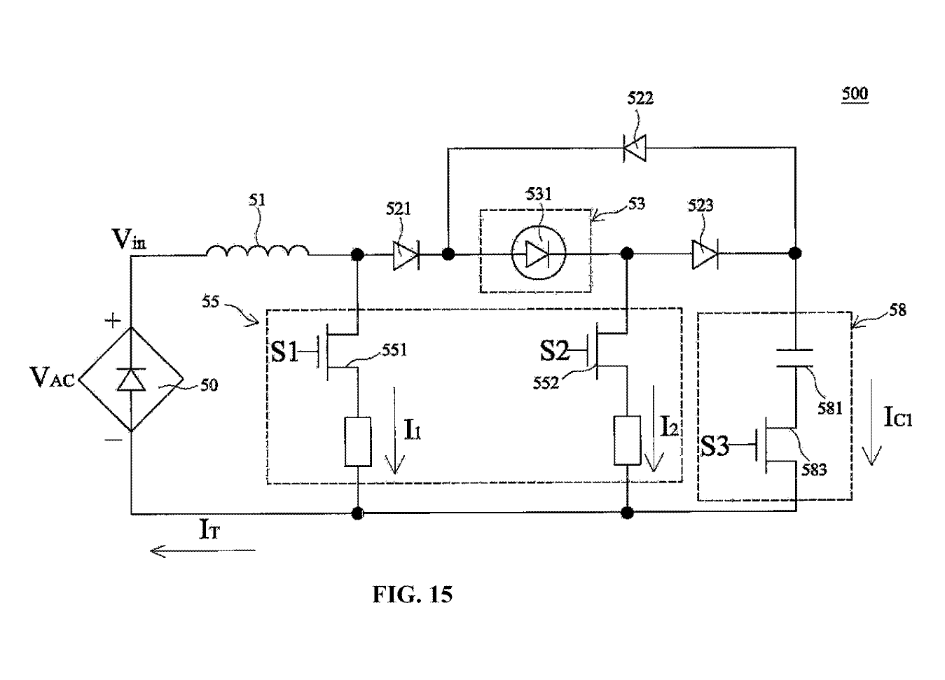

With reference to FIGS. 14 and 15, which show a schematic block diagram and a schematic diagram of another embodiment of the switch circuit in accordance with the present invention. The switch circuit 500 of the present embodiment comprises an unidirectional power source module 50, an inductor 51, an unidirectional load module 53 having a constant-voltage load element 531, a switch module 35 and a back energy storing module 58.

The unidirectional power source module 50 converts an AC power V_{AC} to an input voltage V_{IN}. One terminal of the inductor 51 is connected to the first node of the unidirectional power source module 50, and the other terminal of the inductor 51 is connected to the first node of the unidirectional load module 43 by a first unidirectional conduction element 521. The switch module 55 comprises a first switch 551 and a second switch 552. A first terminal of the first switch 551 is connected to the other terminal of the inductor 51, a control terminal of the first switch 551 is configured to receive a first control signal S1, and a second terminal of the first switch 551 is connected to the second node of the unidirectional power source module 40. A first terminal of the second switch 552 is connected to the second node of the unidirectional load module 53, a control terminal of the second switch 552 is configured to receive a second control signal S2, and a second terminal of the second switch 552 is connected to the second node of the unidirectional power source module 50. Wherein, the first switch 551 is turned ON or OFF according to the first control signal S1, and the second switch 552 is turned ON or OFF according to the second control signal S2. The back energy storing module 58 comprises a back capacitor 581, one terminal of the back capacitor 581 is connected to the first node of the unidirectional load module 53 by a second unidirectional conduction element 522 and connected to the second node of the unidirectional load module 53 by a third unidirectional conduction element 523, and the other terminal of the back capacitor 581 is connected to the second node of the unidirectional power source module 50.

In a method for controlling the switch module 55 in accordance with the present embodiment, a switching operation is performed by the first switch 551. When the first switch 551 is turned ON, the inductor 51 is enabled to store the electrical energy, and the sensing current I1 rises continuously. When the sensing current I1 exceeds a predetermined value, the first switch 551 is turned OFF, and the current discharged from the inductor 51 flows through the unidirectional load module 53 (emitting light) and the back capacitor 581 (charging) and then flows back to the second node of the unidirectional power source module 50 so as to form a loop. Later on, the current of the inductor 51 will decrease over time due to the discharging. When the total current I_{T} of the circuit decreases to another predetermined value, the first switch 551 is turned ON again, and the inductor 51 is charged again.

In addition, the second switch 552 is synchronized to the first switch 551 with the same phase for performing the switching operation, e.g., when the first switch 551 is turned ON, the second switch 552 is also turned ON. If the stored voltage of the back capacitor 581 is larger than the forward voltage of the unidirectional load module 53, the current discharged from the back capacitor 581 flows through the second unidirectional conduction element 552, the unidirectional load module 53 (emitting light) and the second switch 552, and then flows back to the second terminal of the back capacitor 581 so as to form a loop; or when the first switch 551 is turned OFF, the second switch 552 is also turned OFF. The current discharged from the back capacitor 581 flows through the unidirectional load module 53 (emitting light) and the back capacitor 581 (charging), and then flows back to the second node of the unidirectional power source module 50 so as to form a loop.

Of course, the second switch 552 may be synchronized to the first switch 551 with the opposite phase for performing the switching operation. e.g., when the first switch 551 is turned OFF, the second switch 552 is turned ON. The current discharged from the inductor 51 flows through the unidirectional load module 53 (emitting light) and the second switch 552, and then flows back to the second terminal of the unidirectional power source module 50 so as to form a loop. In the meantime, if the back capacitor 581 stores a higher electrical energy, the current discharged from the back capacitor 581 flows through the second conduction element 522, the unidirectional load module 53 (emitting light) and the second switch 552, and then flows back to the second node of the back capacitor 581 so as to form a loop. In the meantime, the operating current of the unidirectional load module 53 is the sum of the current of two loops.

Similarly, the aforementioned method for controlling the switch module 55 is just an embodiment in accordance of the present invention. Herein, the first control signal S1 synchronized to the second signal S2 with the same phase or opposite phases, or the first control signal S1 asynchronous to the second signal S2 for controlling the switching operation of the switch module 55 could be made thereto by those skilled in the art without departing from the scope and spirit of the switch circuit 500.

In addition, the back capacitor 581 of the back energy storing module 58 of the present embodiment may also be connected in series to a third switch 583. In the charging procedure of the back capacitor 581, by controlling the third signal S3 to switch the third switch 583, charging current and charging time of the back capacitor 581 may be modulated so as to improve the power factor of the entire circuit system. In addition, by limiting the charging current of the back capacitor 581, the capacitance of the back capacitor 581 may be reduced so as to reduce its volume and the cost.

The invention described above is just a preferred embodiment, and the invention is not limited by the disclosure. Numerous modifications and variations could be made thereto based on the shapes, configurations, features and spirit of the present invention by those skilled in the art without departing from the scope of the claims hereafter.

1. A switch circuit for controlling supply of electrical energy to a load, comprising:
an unidirectional power source module having a first node and a second node;
an unidirectional load module having a first node and a second node;
an inductor, one terminal of the inductor being connected to the first node of the unidirectional power source module and the second node of the unidirectional load module, the other terminal of the inductor being connected to the first node of the unidirectional load module; and
a switch module comprising a first switch, a first terminal of the first switch being connected to the first node of the unidirectional load module, a control terminal of the first switch being configured to receive a first control signal, and a second terminal of the first switch being connected to the second node of the unidirectional power source module,
wherein the first switch is turned ON or OFF according to the first control signal.

2. The switch circuit according to claim 1, wherein when the first switch is turned ON, the inductor is enabled to store the electrical energy; when the first switch is turned OFF, the inductor is enabled to discharge the electrical energy to the unidirectional load module.

3. The switch circuit according to claim 1, further comprising a front energy storing module, wherein the front energy storing module comprises a front capacitor, one terminal of the front capacitor is connected to the first node of the unidirectional power source module, and the other terminal of the front capacitor is connected to the second node of the unidirectional power source module.

4. The switch circuit according to claim 3, wherein the front energy storing module further comprises a second switch, a first terminal of the second switch is connected to the other terminal of the front capacitor, a control terminal of the second switch is configured to receive a second control signal, and a second terminal of the second switch is connected to the second node of the unidirectional power source module, and wherein the second switch is turned ON, OFF or in current limiting mode according to the second control signal.

5. A switch circuit for controlling supply of electrical energy to a load, comprising:
an unidirectional power source module having a first node and a second node;
an unidirectional load module having a first node and a second node;
an inductor, one terminal of the inductor being connected to the first node of the unidirectional power source module and being connected to the second node of the unidirectional load module by an unidirectional conduction element, the other terminal of the inductor being connected to the first node of the unidirectional load module;
a switch module comprising a first switch, a first terminal of the first switch being connected to the second node of the unidirectional load module, a control terminal of the first switch being configured to receive a first control signal, and a second terminal of the first switch being connected to the second node of the unidirectional power source module, wherein the first switch is turned ON or OFF according to the first control signal; and
a front energy storing module comprising a front capacitor and a second switch, one terminal of the front capacitor being connected to the first node of the unidirectional power source module, a first terminal of the second switch being connected to the other terminal of the front capacitor, a control terminal of the second switch being configured to receive a second control signal, and a second terminal of the second switch being connected to the second node of the unidirectional power source module, wherein the second switch is turned ON, OFF or in current limiting mode according to the second control signal.

6. The switch circuit according to claim 5, wherein when the first switch is turned ON, the inductor is enabled to store the electrical energy; when the first switch is turned OFF, the inductor is enabled to discharge the electrical energy to the unidirectional load module.

7. A switch circuit for controlling supply of electrical energy to a load, comprising:
an unidirectional power source module having a first node and a second node;
an unidirectional load module having a first node and a second node;
an inductor, one terminal of the inductor being connected to the first node of the unidirectional power source module and being connected to the second node of the unidirectional load module by a first unidirectional conduction element, the other terminal of the inductor being connected to the first node of the unidirectional load module; and
a switch module comprising a first switch and a second switch, a first terminal of the first switch being connected to the first node of the unidirectional load module, a control terminal of the first switch being configured to receive a first control signal, and a second terminal of the first switch being connected to the second node of the unidirectional power source module, a first terminal of the second switch being connected to the second node of the unidirectional load module, a control terminal of the second switch being configured to receive a second control signal, and a second terminal of the second switch being connected to the second node of the unidirectional power source module, wherein the first switch is turned ON or OFF according to the first control signal, and the second switch is turned ON or OFF according to the second control signal.

8. The switch circuit according to claim 7, wherein the first switch remains OFF, and the second switch performs a switching operation; or the first switch performs the switching operation, and the second switch remains OFF; or the first control signal is synchronized to the second signal with the same phase or opposite phases; or the first control signal is asynchronous to the second signal.

9. The switch circuit according to claim 7, further comprising a front energy storing module, wherein the front energy storing module comprises a front capacitor and a third switch, one terminal of the front capacitor is connected to the first node of the unidirectional power source module, a first terminal of the third switch is connected to the other terminal of the front capacitor, a control terminal of the third switch is configured to receive a third control signal, and a second terminal of the third switch is connected to the second node of the unidirectional power source module, and wherein the third switch is turned ON, OFF or in current limiting mode according to the third control signal.

10. A switch circuit for controlling supply of electrical energy to a load, comprising:
an unidirectional power source module having a first node and a second node;
an unidirectional load module having a first node and a second node;
an inductor, one terminal of the inductor being connected to the first node of the unidirectional power source module, the other terminal of the inductor being connected to the first node of the unidirectional load module;
a switch module comprising a first switch, a first terminal of the first switch being connected to the first node or the second node of the unidirectional load module, a control terminal of the first switch being configured to receive a first control signal, and a second terminal of the first switch being connected to the second node of the unidirectional power source module, wherein the first switch is turned ON or OFF according to the first control signal; and
a back energy storing module comprising a back capacitor, one terminal of the back capacitor being connected to one terminal of the inductor by a first unidirectional conduction element and being connected to the second node of the unidirectional load module by a second unidirectional conduction element, and the other terminal of the back capacitor being connected to the second node of the unidirectional power source module.

11. The switch circuit according to claim 10, wherein the switch module further comprises a second switch, a first terminal of the second switch is connected to the first node or the second node of the unidirectional load module, a control terminal of the second switch is configured to receive a second control signal, and a second terminal of the second switch is connected to the second node of the unidirectional power source module, and wherein the second switch is turned ON or OFF according to the second signal.

12. The switch circuit according to claim 11, wherein the first switch remains OFF, and the second switch performs a switching operation; or the first switch performs the switching operation, and the second switch remains OFF; or the first control signal is synchronized to the second signal with the same phase or opposite phases; or the first control signal is asynchronous to the second signal.

13. The switch circuit according to claim 10, wherein the back energy storing module further comprises a third switch, a first terminal of the third switch is connected to the other terminal of the back capacitor, a control terminal of the third switch is configured to receive a third control signal, and a second terminal of the third switch is connected to the second node of the unidirectional power source module, and wherein the third switch is turned ON, OFF or in current limiting mode according to the third control signal.

14. A switch circuit for controlling supply of electrical energy to a load, comprising:
an unidirectional power source module having a first node and a second node;
an unidirectional load module having a first node and a second node;
an inductor, one terminal of the inductor being connected to the first node of the unidirectional power source module, the other terminal of the inductor being connected to the first node of the unidirectional load module by a first unidirectional conduction element;
a switch module comprising a first switch and a second switch, a first terminal of the first switch being connected to the other terminal of the inductor, a control terminal of the first switch being configured to receive a first control signal, and a second terminal of the first switch being connected to the second node of the unidirectional power source module, a first terminal of the second switch being connected to the second node of the unidirectional load module, a control terminal of the second switch being configured to receive a second control signal, and a second terminal of the second switch being connected to the second node of the unidirectional power source module, wherein the first switch is turned ON or OFF according to the first control signal, and the second switch is turned ON or OFF according to the second control signal; and
a back energy storing module comprising a back capacitor, one terminal of the back capacitor being connected to the first node of the unidirectional load module by a second unidirectional conduction element and being connected to the second node of the unidirectional load module by a third unidirectional conduction element, and the other terminal of the back capacitor being connected to the second node of the unidirectional power source module.

15. The switch circuit according to claim 14, wherein the first switch remains OFF, and the second switch performs a switching operation; or the first switch performs the switching operation, and the second switch remains OFF; or the first control signal is synchronized to the second signal with the same phase or opposite phases; or the first control signal is asynchronous to the second signal.

16. The switch circuit according to claim 14, wherein the back energy storing module further comprises a third switch, a first terminal of the third switch is connected to the other terminal of the back capacitor, a control terminal of the third switch is configured to receive a third control signal, and a second terminal of the third switch is connected to the second node of the unidirectional power source module, and wherein the third switch is turned ON, OFF or in current limiting mode according to the third control signal.

17. The switch circuit according to claim 1, wherein the unidirectional load module comprises a constant-voltage load element.

18. The switch circuit according to claim 17, wherein the unidirectional load module further comprises a load capacitor, the load capacitor is connected in parallel to the constant-voltage load element.

19. The switch circuit according to claim 5, wherein the unidirectional load module comprises a constant-voltage load element.

20. The switch circuit according to claim 7, wherein the unidirectional load module comprises a constant-voltage load element.

21. The switch circuit according to claim 10, wherein the unidirectional load module comprises a constant-voltage load element.

22. The switch circuit according to claim 14, wherein the unidirectional load module comprises a constant-voltage load element.

23. The switch circuit according to claim 19, wherein the unidirectional load module further comprises a load capacitor, the load capacitor is connected in parallel to the constant-voltage load element.

24. The switch circuit according to claim 20, wherein the unidirectional load module further comprises a load capacitor, the load capacitor is connected in parallel to the constant-voltage load element.

25. The switch circuit according to claim 21, wherein the unidirectional load module further comprises a load capacitor, the load capacitor is connected in parallel to the constant-voltage load element.

26. The switch circuit according to claim 22, wherein the unidirectional load module further comprises a load capacitor, the load capacitor is connected in parallel to the constant-voltage load element.
